(19) United States
(12) Patent Application Publication
(10) Pub. No.: US 2025/0313321 A1
(43) Pub. Date: Oct. 9, 2025

(54) KITE LAUNCHING AND LANDING ASSIST DEVICE AND FLOATING UNIT

(71) Applicant: TOYOTA JIDOSHA KABUSHIKI KAISHA, Toyota-shi (JP)

(72) Inventors: Tateru FUKAGAWA, Fujisawa-shi (JP); Tetsuyuki OE, Koganei-shi (JP); Mikikane HIROHATA, Sunto-gun (JP); Yoshiharu SAITO, Gotemba-shi (JP); Hayato MASUKI, Fuji-shi (JP)

(73) Assignee: TOYOTA JIDOSHA KABUSHIKI KAISHA, Toyota-shi (JP)

(21) Appl. No.: 19/042,752

(22) Filed: Jan. 31, 2025

(30) Foreign Application Priority Data
Apr. 9, 2024 (JP) 2024-062959

(51) Int. Cl. B63H 9/069

(52) U.S. Cl. CPC B63H 9/069

(57) ABSTRACT

A kite launching and landing assist device includes a cavity support portion in which a kite is detachably secured by tension of the tether when the tether is wound with a winch, and a cavity serving as an air channel is secured in a direction intersecting with a wind receiving surface of the kite, and includes a launching and landing buoy that is detachable from or detachable from the floating unit and is floatable.

### CROSS-REFERENCE TO RELATED APPLICATION

This application claims priority to Japanese Patent Application No. 2024-062959 filed on Apr. 9, 2024, incorporated herein by reference in its entirety.

### BACKGROUND

### 1. Technical Field

The present disclosure relates to kite launching and landing assist devices that assist in launching and landing a kite in a floating unit and floating units. The floating unit is, for example, a yacht floating on water, and constitutes a system that uses a kite, such as a tethered wind power generation system, an observation system, a transportation system, or a communication system.

### 2. Description of Related Art

Various types of vessels with sails that fly a kite from their sterns have been proposed as this type of floating unit (see Japanese Unexamined Patent Application Publication No. 2017-191963 (JP 2017-191963 A)). According to these techniques, the vessels are designed to launch a kite from aft of the sails in an aft direction and land the kite on the vessel and thus to launch and land the kite in the same manner as in the case of launching and landing a kite on land.

### SUMMARY

According to the above related art, however, the vessels need to have a considerably large launching and landing area in an area aft of the sails in order to launch and land a kite. If the vessels do not have such a large launching and landing area, a kite or a tether with the kite attached thereto may interfere with the sails especially when the kite is flapping in a strong or stormy wind. The above related art is therefore technically disadvantageous in that an increase in size of the floating unit, or interference between the tether or kite and the sails and a failure in launching and landing due to the interference, may not be able to be avoided.

An object of the present disclosure is to provide a kite launching and landing assist device that allows smooth launching and landing of a kite in a floating unit configured to fly a kite from the water.

In order to solve the above issue, an aspect of a kite launching and landing assist device according to the present disclosure is
a kite launching and landing assist device configured to assist in launching and landing a kite attached to a distal end of a tether in a floating unit including a winch configured to unwind and wind the tether. The kite launching and landing assist device includes:
a launching and landing buoy to which the kite is detachably secured with a tension of the tether from the winch when the tether is wound around the winch, the launching and landing buoy including a cavity support portion in which a cavity configured to serve as an air channel is provided in a direction intersecting a wind receiving surface of the kite, and the launching and landing buoy being floatable in such a manner that the launching and landing buoy is separated or detached from the floating unit; and
a drive unit configured to, before launching and landing of the kite, separate the launching and landing buoy to a position where the tether or the kite does not interfere with the floating unit, and after the landing of the kite, tow or connect the launching and landing buoy to the floating unit.

With the kite launching and landing assist device of the aspect of the present disclosure, the kite can be smoothly launched and landed with the wind receiving surface of the kite receiving wind through the cavity of the launching and landing buoy. Moreover, separating the launching and landing buoy from the floating unit in a horizontal direction allows to avoid interference between the tether or kite and the floating unit during launching and landing, and thus allows reduction in size of the floating unit. Furthermore, after landing etc., the launching and landing buoy to which the kite is secured and the floating unit are connected or combined together by the drive unit. This provides overall stability on the water and facilitates sailing.

Such functions and effects according to the present disclosure will become more apparent from the embodiment of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view (part 1) showing a configuration of a kite launching and landing assist device provided in a floating unit according to an embodiment together with main parts thereof;

FIG. 2 is a schematic side view (part 2) showing a configuration of a kite launching and landing assist device provided in the floating unit according to the embodiment together with main parts thereof; and

FIG. 3 is a schematic side view (part 3) showing a configuration of a kite launching and landing assist device provided in the floating unit according to the embodiment together with main parts thereof.

### DETAILED DESCRIPTION OF EMBODIMENTS

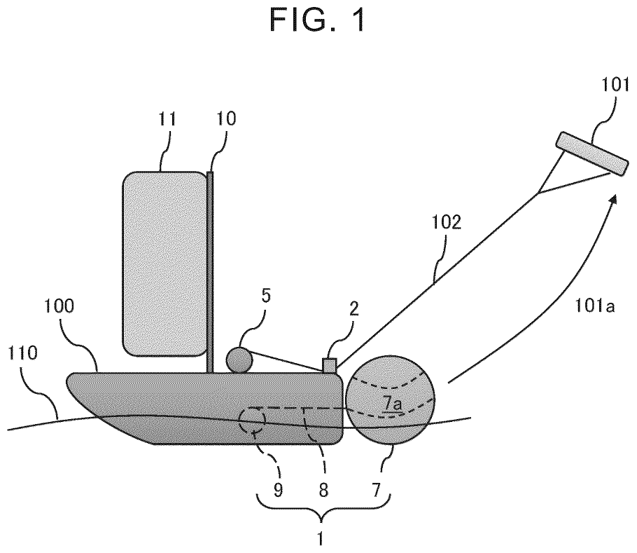

Referring to FIGS. 1 to 3, a description will be given of a kite launching and landing assist device provided in a floating unit for lifting a kite according to an embodiment. In the present embodiment, for example, a tether-type wind power generation system is constructed by a floating unit such as a yacht or an offshore unit together with a kite side unit including a kite fried therefrom.

As shown in FIG. 1, the floating unit 100 according to the present embodiment is floated on the water surface 110 and includes the launching and landing assist device 1 of the kite 101, the winch 5 that unwinds and winds the tether 102 of the kite 101, and the mast 10 and the sail 11. On the deck at the rear of the floating unit 100, there is provided a movable pulley 2 which defines a feeding and feeding position of the tether 102 from the floating unit 100 corresponding to the unwinding and winding of the winch 5. The movable pulley 2 may be configured to move or rotate horizontally or vertically on the deck of the floating unit 100. Alternatively, the mobile pulley may not be mobile, but may be secured to the stern of the floating unit 100.

The mast 10 and the sail 11 are configured to enable the floating unit 100 to navigate as a yacht. The floating unit 100 is preferably constructed as a catamaran vessel or a multi-hull vessel having excellent navigation performance and stability. The floating unit 100 may be caused to float on the water surface 110 on any water surface, such as on a lake, a river, or the like, in addition to the sea or the ocean.

The launching and landing assist device 1 is configured to include a buoy 7 which constitutes an example of a “launching and landing buoy” and has a cavity support portion for securing a cavity 7a therein, a wire 8 whose leading end is connected to the buoy 7, and an auxiliary winch 9 which constitutes an example of a “drive unit” capable of winding up and unwinding the root side of the wire-8. In the state of FIG. 1, the auxiliary winch 9 has fully wound the wire 8, and the buoy 7 has been pulled to the floating unit 100 and connected or secured to the floating unit 100.

In FIG. 1, the tether 102 is unwound, and the kite 101 is raised above the wind 101a indicated by the arrow to the sky of a strong wind suitable for tethered wind power generation. In this state, on the floating unit 100, power is generated by causing the winch 5 to function as a generator for tethered wind power generation. The electric power generated here is stored in, for example, a storage battery (not shown) or the like provided in the floating unit 100, or is stored as hydrogen energy by being converted into hydrogen, or is wired or wirelessly output as electricity, an electromagnetic wave, a laser, or the like. In this way, the tether-type power generation system including the floating unit 100 and the kite-side unit is used for power generation.

In the present embodiment, in particular, the buoy 7 has a cavity support portion that defines or secures a cavity 7a, and when launching the kite 101, the wind in the vicinity of the water surface 110 is passed through the cavity 7a, so that the wind can be applied to the wind receiving surface of the kite 101 through the buoy 7. Consequently, launching of the kite 101 from the buoy 7 can be smoothly performed by the wind including the wind 101a hitting the kite 101 via the cavity 7a.

From the viewpoint of effectively utilizing such wind 101a, the cavity support portion of the buoy 7 has a contact surface that contacts the wind receiving surface of the kite 101 at a predetermined launching angle when launching the kite 101, whereby the angle of the contact surface may be set so that the cavity 7a becomes a channel through the wind 101a that raises the kite 101. That is, by setting the angle of the contact surface to a predetermined angle, it is possible to easily launch the kite 101. Such an angle may be set experimentally, empirically, mathematically, or by simulation as an angle at which the kite 101 is most likely to rise. On the other hand, the contact surface may be angled such that the cavity 7a is a channel through which the air that lowers the kite 101 is passed or a channel that uses the air as fine air so that smooth landing can be performed. Alternatively, the angle of the contact surface or the shape of the cavity 7a may be set to an angle or a shape of the cavity 7a that facilitates launching of the kite 101 during launching and that facilitates landing of the kite 101 during landing.

Such a cavity 7a does not need to be one, and may be configured to include a plurality or a plurality of communication holes as long as the wind 101a is meaningfully passed therethrough, and the cavity support portion of the buoy 7 may be configured from a cleared frame or from a punched material or a mesh-like material. In addition, the tether 102 may be configured to pass through the cavity 7a, unlike the configuration of FIG. 1, or may be configured not to pass through the cavity 7a, as in the configuration of FIG. 1, as long as the wind 101a passing through the cavity 7a is appropriately applied to the kite 101.

Further, the buoy 7 may be configured to integrally include a cavity support portion and a buoy portion floating in water. For example, the buoy 7 can be integrally formed from a member having a buoyancy function, a cavity function, a function of carrying strength, and the like. That is, the launching and landing assist device 1 can be constructed to have high functionality by making it relatively easy or inexpensive. However, the buoy 7 may be composed of a plurality of components or members, for example, a component that contributes to buoyancy, a component that contributes to securing a cavity 7a, and a component that contributes to feeding and feeding the tether 102 through the launching and landing assist device 1.

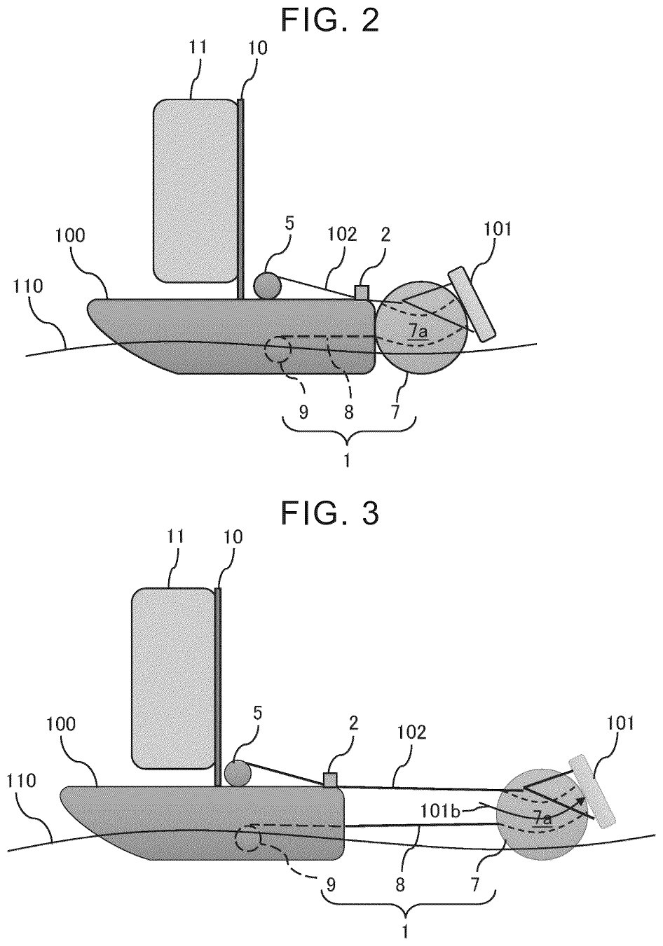

Next, as shown in FIG. 2, when the power generation work in the state shown in FIG. 1 is completed, the winch 5 is wound up in order to land the kite or to make an emergency landing, and the tether 102 is inserted through the movable pulley 2 in response thereto. In parallel or in parallel, winding of the wire 8 by the auxiliary winch 9 is performed, and the buoy 7 is pulled toward the floating unit 100.

As a result, the kite 101 is secured to the launching and landing assist device 1 by the tension applied from the winch 5 via the tether 102, and the launching/landing assist device 1 is secured to the floating unit 100. That is, a part of the wind receiving surface of the kite 101 comes into contact with the contact surface of the buoy 7, so that the kite 101 is secured. As previously discussed, the tether 102 may be configured to pass through the cavity 7a, unlike the configuration of FIGS. 1 and 2, where the face bordering the cavity 7a will contact the wind receiving surface of the kite 101 as a contact surface.

Note that the buoy 7 is not merely connected to the floating unit 100, and may be stored in a storage position, a storage space, or a storage box provided in the floating unit 100, or may be configured to be pulled up on the deck of the floating unit 100. At this time, the storage operation and the pulling operation may be performed by the driving force of the winch 5 or the auxiliary winch 9 or the driving force of both of them.

Next, as shown in FIG. 3, when the operation of moving the floating unit 100 to the destination in the state shown in FIG. 2, the navigation operation, and the like are completed, the winch 5 unwinds in order to launch the kite 101 for the next tether-type wind power generation, and the tether 102 is paid out through the movable pulley 2 in response thereto. In parallel with this, the wire 8 is unwound by the auxiliary winch 9, and the buoy 7 is separated from the floating unit 100.

As a result, the kite 101 is separated to a position where it does not interfere with the floating unit 100, particularly the mast 10 and the sail 11. At this position, the kite 101 is smoothly launched by receiving the wind 101b blown through the cavity 7a on the wind receiving surface. As previously discussed, the tether 102 may be configured to pass through the cavity 7a, unlike the configuration of FIGS. 1 to 3, where the edge of the cavity 7a will define the delivery position of the tether 102 from the launching and landing assist device 1 or the buoy 7 of the kite 101.

When the launching shown in FIG. 3 is completed, the kite 101 shown in FIG. 1 is raised to an empty height for tether-type power generation again.

As described above in detail with reference to FIGS. 1 to 3, the buoy 7 is mainly separated from the floating unit 100 by the auxiliary winch 9 for launching and landing of the kite (i.e., for landing or retrieval, storage or securing, and launching), and floats on the water surface 110 at a position away from the floating unit 100. Here, the cavity support portion included in the buoy 7 has a cavity 7a that serves as an air channel in a direction intersecting the wind receiving surface of the kite 101, and therefore, launching and landing can be performed with the wind receiving surface of the kite 101 receiving wind 101b via the cavity 7a. In particular, during landing, the kite 101 can be landed while the kite 101 remains floating in the air by wind or air flowing through the cavity 7a (see FIG. 2). On the other hand, at the time of launching, the kite 101 can be launched by quickly securing a condition in which the kite 101 is easily floated in the air due to wind 101b by the air flowing through the cavity 7a (see FIG. 3).

Further, since the buoy 7 floating on the water surface 110 at a position away from the floating unit 100 can launch and land the kite 101, it is possible to avoid interference during launching and landing between the tether 102 and the kite 101 and the floating unit 100 (particularly, the sail 11 and the mast 10 thereof). At the same time, since it is not necessary to secure a large space for launching and landing on the floating unit 100, it is also possible to reduce the size of the floating unit 100.

In addition, if the buoy 7 remains fluctuated and suspended at a position separated from the floating unit 100 on the water surface 110, for example, a tow operation or a navigation operation, a standby operation, a tether-type power generation operation, or the like in the floating unit 100 may be hindered. However, before launching after or after landing as shown in FIG. 2 (i.e., after collection of the kite 101, when the kite 101 is stored or secured, or when the floating unit 100 is moved to a destination or a base, etc.), or after launching when the kite 101 is flying high as shown in FIG. 1 (i.e., tether-type power generation using the kite, observation, transportation, communication, etc.), the buoy 7 is towed or connected to the floating unit 100 mainly by the auxiliary winch 9, so that the floating unit 100 and the launching and landing assist device 1 are secured to each other and are integrated as a whole, so that the above-described problems can be prevented.

### Additional Remarks

With regard to the embodiments described above, the following additional notes are further disclosed.

### APPENDIX 1

The kite launching and landing assist device according to Appendix 1 of the present disclosure is provided with a winch for unwinding and winding a tether. A kite launching and landing assist device for assisting launching and landing of a kite attached to a tip of the tether, wherein the tether is wound up by the winch, and a cavity support portion in which a cavity configured to serve as an air channel is provided in a direction intersecting a wind receiving surface of the kite, and a launching and landing buoy which is separated or detached from the floating unit is provided. The launching and landing buoy is landed. A drive unit is provided for separating the tether or the kite from the floating unit and pulling or connecting to the floating unit after landing of the kite.

According to the kite launching and landing assist device according to Appendix 1 of the present disclosure, the launching and landing buoy is separated from the floating unit by a drive unit for launching and landing of the kite, and floats on water or the ocean at a position away from the floating unit. Here, the cavity support portion included in the launching and landing buoy has a cavity that serves as an air channel in a direction intersecting the wind receiving surface of the kite, and thus launching/landing can be performed in a state where the wind receiving surface of the kite receives wind through the cavity. In particular, during launching, a state in which the kite is likely to float in the air due to the wind can be quickly secured by the air flowing through the cavity to launch the kite.

Further, since the launching and landing buoy floating on the water at a position away from the floating unit allows launching and landing of the kite, it is possible to avoid interference at the time of launching and landing between the tether or the kite and the floating unit. At the same time, since it is not necessary to secure a large space on the floating unit for launching and landing, it is also possible to reduce the size of the floating unit.

In addition, if the launching and landing buoy remains floating at a position separated from the floating unit on the water, for example, towing operation or navigation operation in the floating unit may be hindered. However, before or after a launching, or after a launching where the kite is flying high, the drive unit pulls or connects the launching and landing buoy to the floating unit, so that the floating unit and the launching and landing buoy become a single unit or an integral unit, thereby preventing problems as described above.

### APPENDIX 2

The kite launching and landing assist device according to Appendix 2 of the present disclosure is the kite launching and landing assist device according to Appendix 1, wherein the cavity support portion has a contact surface that contacts the wind receiving surface at a predetermined launching angle when launching the kite.

According to the kite launching and landing assist device according to Appendix 2 of the present disclosure, the angle of the contact surface is set so that the cavity becomes a channel through which the wind for raising the kite is passed, that is, the contact surface is set to a predetermined launching angle, so that the kite can be easily launched.

### APPENDIX 3

The kite launching and landing assist device according to Appendix 3 of the present disclosure is the kite launching and landing assist device according to Appendix 1 or 2, wherein the drive unit is configured to be capable of driving the launching and landing buoy toward the floating unit until the launching and landing buoy is stored at the storage position of the floating unit.

According to the rollover prevention device described in Appendix 3 of the present disclosure, if there is a launching and landing buoy separated from the floating unit on the water surface, the power generation operation, the towing operation, the standby operation, and the like in the floating unit may be hindered. However, according to the device described in Appendix 3, by storing the launching and landing buoy in the storage position or the storage space provided behind the floating unit by the drive unit, such trouble can be prevented in advance.

### APPENDIX 4

The kite launching and landing assist device according to Appendix 4 of the present disclosure is the kite launching and landing assist device according to any one of Appendices 1 to 3, wherein the launching and landing buoy integrally has the cavity support portion and a buoy portion configured to float on water.

According to the rolling prevention device described in Appendix 4 of the present disclosure, the launching and landing buoy can be integrally formed from a component or a member having a buoyancy function, a cavity function, a function of carrying strength, and the like. That is, the launching and landing assist device can be constructed to have high functionality by making it relatively easy or inexpensive.

### APPENDIX 5

The floating unit according to Appendix 5 of the present disclosure includes the kite launching and landing assist device according to any one of Appendices 1 to 4.

According to the floating unit described in Appendix 5 of the present disclosure, since it has the kite launching and landing assist device according to any one of Appendices 1 to 4 described above, without interfering with the floating unit, it is possible to smoothly launch and land the kite, and it is also possible to reduce the size of the floating unit.

The present disclosure can be modified as appropriate within the scope and spirit of the disclosure that can be read from the claims and the specification as a whole, and a kite launching and landing assist device base or a floating unit with such a modification is also included in the technical idea of the present disclosure.

What is claimed is:

1. A kite launching and landing assist device configured to assist in launching and landing a kite attached to a distal end of a tether in a floating unit, the floating unit including a winch configured to unwind and wind the tether, the kite launching and landing assist device comprising:
a launching and landing buoy to which the kite is detachably secured with a tension of the tether from the winch when the tether is wound around the winch, the launching and landing buoy including a cavity support portion in which a cavity configured to serve as an air channel is provided in a direction intersecting a wind receiving surface of the kite, and the launching and landing buoy being floatable in such a manner that the launching and landing buoy is separated or detached from the floating unit; and
a drive unit configured to, before launching and landing of the kite, separate the launching and landing buoy to a position where the tether or the kite does not interfere with the floating unit, and after the landing of the kite, tow or connect the launching and landing buoy to the floating unit.

2. The kite launching and landing assist device according to claim 1, wherein the cavity support portion includes a contact surface configured to contact the wind receiving surface at a predetermined launching angle when the kite is launched.

3. The kite launching and landing assist device according to claim 1, wherein the drive unit is configured to drive the launching and landing buoy toward the floating unit until the launching and landing buoy is stored at a storage position on the floating unit.

4. The kite launching and landing assist device according to claim 1, wherein the launching and landing buoy integrally includes the cavity support portion and a buoy portion configured to float on water.

5. A floating unit comprising the kite launching and landing assist device according to claim 1.
